(19) United States
(12) Patent Application Publication
(10) Pub. No.: US 2004/0209230 A1
(43) Pub. Date: Oct. 21, 2004

(54) System and method for representing information

(75) Inventors: Andreas Beu, Hofolding (DE); Gunthard Triebfuerst, Nuemberg (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 10/626,746

(22) Filed: Jul. 25, 2003

Related U.S. Application Data
(63) Continuation of application No. PCT/DE02/00107, filed on Jan. 16, 2002.

(30) Foreign Application Priority Data
Jan. 25, 2001 (DE) 101 03 462.8
Apr. 26, 2001 (DE) 101 20 574.0

(51) Int. Cl. G09B 25/00

(52) U.S. Cl. 434/72

(57) ABSTRACT

A system and a method for representing information, and a computer program product for implementing the method, which improve the representation of information in terms of user-friendliness. The information representation system contains a display device (1) for displaying information which is called up according to a current context. A context manager (23) manages context objects (6) and dynamically selects the context objects as a function of the current context of a user (3). The context manager also offers the selected context objects to the user for display. The context objects contain respective individual data records with information and functions, taken from a database(7), specific to the context. The context of the user is determined by a spacial position, a work object and/or a work task of the user. The context object(s) of interest to the user are selected via a context-specific menu that has a control component enabling access to the specific information and functions associated with that context object. The display device (1) displays a context display (29) visualizing the information and functions for the context object of interest.

This is a Continuation of International Application PCT/DE02/00107, with an international filing date of Jan. 16, 2002, which was published under PCT Article 21(2) in German, and the disclosure of which is incorporated into this application by reference.

### FIELD OF AND BACKGROUND OF THE INVENTION

The present invention relates to a system and a method of representing information, as well as to a computer program product.

Such a system and method are used, e.g., in the field of automation technology, in production machines and machine tools, in diagnostic and support systems and for complex components, equipment and systems, such as motor vehicles, industrial machines and installations, in particular in the specific context of the application field “augmented reality in service.”

### OBJECTS OF THE INVENTION

One object of this invention is to improve the procurement of information and functions from the standpoint of user friendliness.

### SUMMARY OF THE INVENTION

This and other objects are achieved, according to one formulation, by a system for acquiring information and functions from a database, which includes: least one context object containing a data record that has information and functions from the database and a context-specific menu that has a control component enabling access by a user to the context object, a context manager managing the context objects and dynamically selecting the context objects as a function of a current context of the user, whereby the context manager offers the selected context objects to the user, and a display device displaying a context display for visualizing the selected context objects, wherein the context of the user is determined by at least one of a position in space, a work object and a work task of the user.

According to another formulation, the invention is directed to a method of acquiring information and functions from a database, wherein at least one context object contains a data record having information and functions from the database, the method including: managing the context objects and dynamically selecting the context objects as a function of a current context of the user; determining the current context of the user by at least one of a spatial position, a work object and a work task of the user; offering the selected context objects to the user; and displaying a context display of ones of the selected context objects.

Many complex activities in the fields of service, maintenance and production require a high level of supporting information and functions at the right time and the right place. Mobile augmented reality (AR) technology permits access to a very extensive database in these areas. Information management systems offer access to a variety of information, but only a portion of this pool is needed to handle a concrete task. Which information is needed depends on the context and the user's task. In conventional information management systems, the user must first search for the information of interest to him at the current point in time, but this is often quite time consuming. Traditional user interfaces usually require a relatively complex search and/or navigation dialog to find the corresponding information or function. Their structure as well as their look and feel are usually static, and they frequently offer a variety of options, although only some of these options are needed to handle a concrete task, and they can be adapted to the user's current needs only to a limited extent. Other requirements of the user interface of mobile AR systems are based on the size of the displays, which are much smaller than PC monitors (so-called “babyface”). To avoid overfilling the display (display clutter), if possible only the information and functions that are important for the user in his current context are to be displayed. This is true to an even greater extent for those augmented reality systems in which computer-generated information (e.g., with a head-mounted display) is inserted directly into the user's field of vision and is thus superimposed on reality. A difficulty thus arises in filtering out the information and functions actually needed by the user for his task from a very large database and presenting them to him in an appropriate form on a mobile AR system.

Information management systems today have so far been based only on stationary systems. The popular graphical user interfaces (desktop metaphors) allow the user to make individual adjustments, e.g., direct access to frequently needed information and functions (e.g., via links on the desktop) or hiding and modifying taskbars. Search functions having extensive configurable criteria are integrated into conventional operating systems, making it possible to locate information at the local workplace, in the local network or in the Internet. The Internet also has a plurality of search engines, often specialized in certain tasks. The option of a full text search permits a search for criteria not taken into account in creation of the corresponding information databases. Offline search systems automatically perform Internet searches according to user specifications. All the current solutions described require of the user a high level of planning and concrete specifications of the system. Although the context in which the user is searching for certain information is usually clear to him, the user must convey this to the system through complex criteria specifications. For short-term tasks, the required complexity here is often too great to yield usable results.

The present invention offers a tool in the form of a system for acquiring information and functions, also referred to below as a context navigator, which offers information and/or functions to the user of mobile AR systems, depending on his context (in particular, location, task, persons, work object). The context navigator makes it possible to rapidly and efficiently access information from an extensive database by offering the user a meaningful preselection. This preselection is generated dynamically from the current context. The user receives an adjusted selection of information and functions, depending on his spatial location, the current work object, the work task and possible communication partners. The spatial context, work objects (e.g., components) and communication partners (e.g. other people present) are automatically detected by the system by AR tracking; work tasks and/or work sequences are monitored and a workflow engine is controlled. The user can decide which of the automatically recognized objects are displayed in his mobile AR system; he can manually add additional elements (e.g., by a search), and he constantly has direct access to the objects he has selected. In comparison with an office workplace, mobile use of a computer system makes increased demands with regard to efficient and rapid access to the required data, but at the same time it also offers the possibility of obtaining, from the spatial context, information about which information or functions are important or beneficial for the user in the current situation.

With the help of an AR tracking system, the context navigator recognizes the spatial context (location, components, persons present), and with the help of a workflow engine, it recognizes the user's work context. On the basis of this information, the user interface makes adjustments and displays the information and functions that are relevant in the current context - e.g., for the current working step on the current component. The context navigator acts like a dynamic filter on the database and is thus able to supply the “right” information and functions at the right point in time. The user has the possibility of direct access to a plurality of context objects, which are presented to him in the display through context-specific menus which allow access to the respective information and functions. These context-specific menus may contain references to “related” context objects (e.g., to components which are functionally linked to the component currently being worked on). The user can at any time remove the context objects offered to him from the display if he no longer needs them.

The present invention uses a tracking system, which is a system capable of detecting and recognizing objects (e.g., rooms, machines, components). Detection is advantageously performed via an image acquisition unit. The information acquired is analyzed in a computer unit. With the help of the tracking system, the location of the user and the context in which he finds himself are determined, and this information is relayed to the computer unit. The term “context” is understood to refer to information which is in a spatial, temporal or functional relationship to the user, e.g., his concrete work situation, his physical environment, his viewing direction and his focus, but also the presence of external faults or information which might be relevant for the user. Messages regarding external interference and information are generated in the first control component. This also includes the information system, which “filters” through the given context instructions and makes available the information that is relevant at the moment. If a certain context is detected by the tracking system, it forms a so-called context object and appears symbolically as a “button” in a type of “taskbar.” The user can switch between different context objects by manipulating these buttons, i.e., the second control component. Each context object has its own menu which contains the option of abandoning the context object. Thus, with the help of a conventional tracking system for augmented reality applications, the possibilities and potentials of context acquisition can be applied to the design, structure and organization of a user interface to ensure rapid and user-friendly navigation, orientation and operability. The user remains mobile because the display device is designed as the display of a mobile computer system. The context navigator and its components are implemented in one or more mobile or stationary computer systems.

### BRIEF DESCRIPTION OF THE DRAWINGS

The present invention is explained in greater detail below on the basis of the exemplary embodiments illustrated in the figures, which show:

FIG. 1 an overview of the functioning of the context navigator;

FIG. 2 the context object, including information, functions and notes;

FIG. 3 the context navigator visualized on a hand-held display;

FIG. 4 the context navigator visualized on a head-mounted display;

FIG. 5 an illustration of the context navigator at granularity level 1;

FIG. 6 an illustration of the context navigator at granularity level 1 with a change in spatial position in comparison with FIG. 5;

FIG. 7 an illustration of the context navigator with a change in granularity level; FIG. 8 an illustration of the context navigator with the granularity level changed to level 3;

FIG. 9 another exemplary embodiment of the context navigator; and

FIG. 10-FIG. 20 views of a user interface on a display device of the context navigator.

### DETAILED DESCRIPTION OF THE PREFERRED EMBODIMENTS

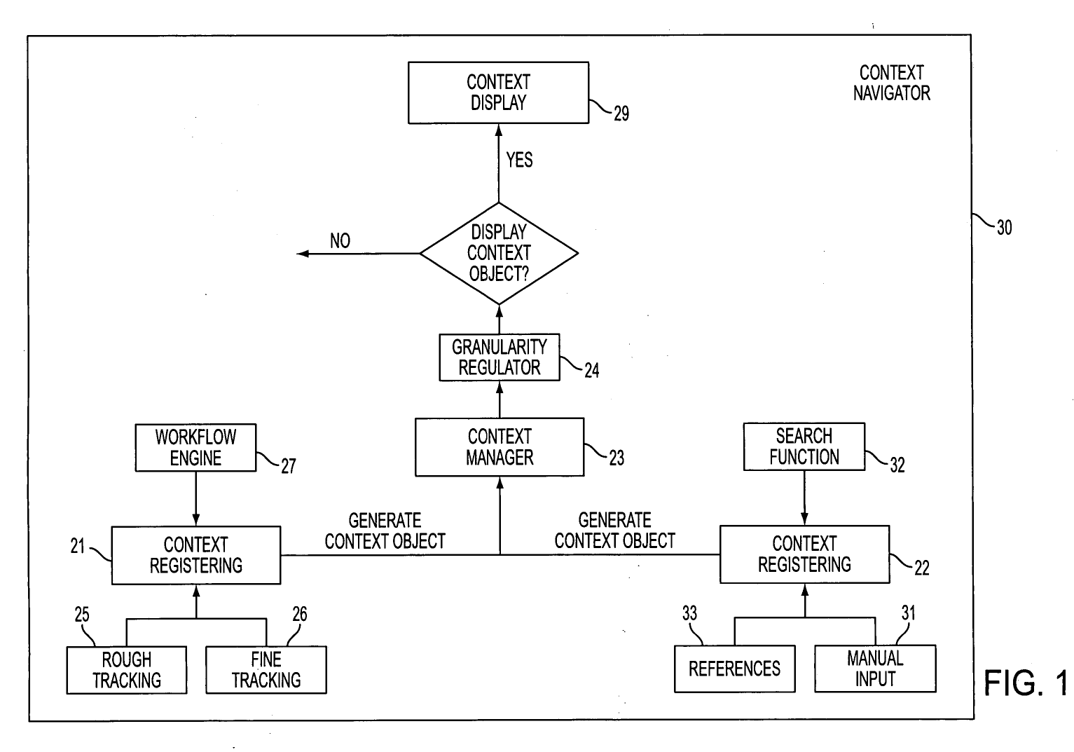

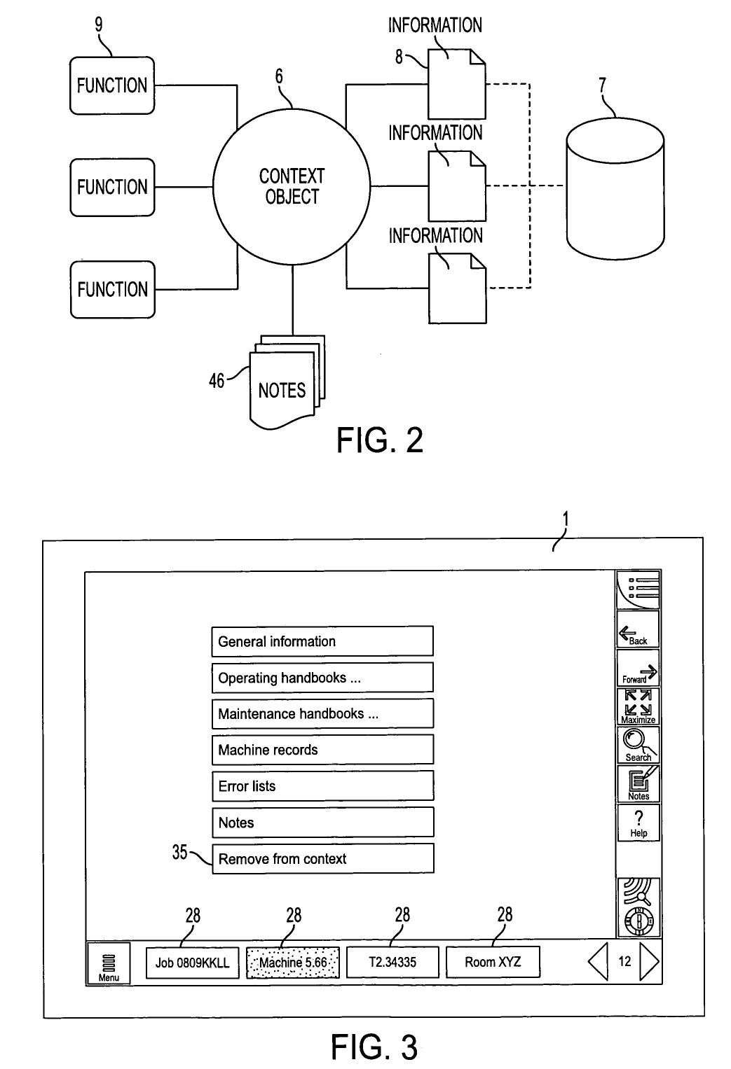

The components used and their interaction are explained below on the basis of FIG. 1 through FIG. 3. First, the terminology used will be reviewed. A context object 6 contains a filtered data record from a database 7, e.g., a data bank, allowing access to information 8 and functions 9. The context objects 6 are generated from the real context by context registering 21, 22. Context manager 23 is the central element of the context navigator 30 and is used to manage the context objects 6. The context manager 23 is responsible for new context objects 6 being transferred into context display 29 for the user 3. Granularity regulator 24 functions as an additional filter. The objects in the context display 29 are presented to the user 3 in the form of context-specific menus 20. Through references, the user 3 has the opportunity to activate a given instruction and thus generate a new context object 6.

FIG. 1 gives an overview of the functioning of the context navigator 30. There are basically two types of registering of context objects 6: automatic and manual context registering. Automatic context registering 21 generates context objects 6 when new objects in the real context are recognized by rough tracking 25 or by fine tracking 26 or by a workflow engine 27. The context objects 6 thus generated are managed in the context manager 23 and are filtered through granularity regulator 24. Here the user 3 can select the “resolution” with which the system is to present him with context objects 6 (e.g., only major components vs. individual parts of subcomponents). In a dialog, the user 3 can decide whether he wants to include the recognized object in his context display 29. Through manual context registering 22, also known as user-guided context registering, the user 3 has an opportunity to generate in a controlled manner context objects 6 which are not currently being detected by the automatic system.

The individual parts of the context navigator 30 will be discussed in greater detail below. Context objects 6 differ in their properties with regard to type, whether they can be generated automatically, whether they are granulable (scalable) and which information 8 and functions 9 can be retrieved for them. Four types of context objects 6 are to be differentiated (see also Table 1): room, work object, communication, workflow. The context display 29 may contain any number of context objects 6 of any types. All the displayed context objects 6 must be removed explicitly by the user 3, but they differ in how they are included in the context display 29. Table 1 below gives an overview of the various types of context objects 6, their specific properties and the respective information 8 and functions 9. Column A shows the respective types of context objects 6, and column B shows the respective subtypes. Columns C, D and E contain information about specific properties of the context objects 6, namely whether they are generated automatically (column C), displayed automatically (column D) or are granulable (column E). Column F lists the respective information 8, and column G lists the respective functions 9.

TABLE 1
Types of context objects 6

| A | B | C | D | E | F | G |
|---|---|---|---|---|---|---|
| Room | Room | yes | yes | no | layout | have the route |
| | Area | yes | yes | no | available | described |
| | | | | | components | switch the |
| | | | | | communication | equipment |
| | | | | | equipment | in the |
| | | | | | | room (lights, |
| | | | | | | ventilation, |
| | | | | | | power |
| | | | | | | supply, etc.) |
| Work | Major | yes | no | yes | manual | read out/ |
| object | com- | | | | circuit diagrams | update the |
| | ponent | yes | no | yes | construction | measured data |
| | Subcom- | | | | drawings | |
| | ponent | | | | parts lists | |
| | | | | | contact people | |
| Commun- | Person | yes | no | yes | name, affiliation | direct |
| ication | (present) | | | | (company, | communication |
| | Person | no | no | yes | department) | sending |
| | (remote) | | | | competency | material, data |
| | | | | | associated people | time-shifted |
| | | | | | reachability | communication |
| Work- | Order | yes | yes | no | working steps | step-for-step |
| flow | Task | yes | no | no | work objects | instructions |
| | | | | | contact people | updating meas- |
| | | | | | | ured values |
| | | | | | | communicating |

The context of the user 3 is monitored continuously and checked for whether the system can offer specific information 8 or functions 9. Automatic context registering 21 monitors the data generated by rough tracking 25 and by fine tracking 26 as well as by the workflow engine 27. As soon as the automatic context recording 21 registers a new object, it generates a context object 6, which is received into the context manager 23. New objects occur when, due to movement of the user 3, the actual spatial context and/or viewing field of the user 3 changes or the workflow engine 27 specifies the next work step. Automatic context recording 21 is also responsible for generating a reference for certain objects that can be used by the user 3 for manual context registering 22.

Context can be registered manually if the user would like to retrieve, e.g., information 8 about the neighboring room, a functionally related component, a certain person or a work sequence. Manual input 31, search function 32 and the selection of references 33 are used as input for manual context registering 22. With manual input 31, only the (known) component number and/or designation is entered; then manual context registering 22 generates the corresponding context object 6, which is transferred to the context manager 23. When using the search function 32, the context object 6 is generated as soon as the desired object has been found. The same thing also applies to the selection of references 33.

References are generated either in the context display 29 of a context object 6 or by automatic context registering 21. They provide the user 3 with the option of making a selection, but the corresponding context object 6 is generated only when an explicit selection is made.

References are presented to the user 3 as entries into the context-specific menus 20 or as a virtual mark (“flag”) on a real object. The user 3 can select a menu entry or a list entry, e.g., on a touchscreen, with a rotary pushbutton or by voice. A flag on a component can be selected by fixing it for a certain period of time or by fixing and confirmation by pushing a button or by voice command. Barcodes or labels that can be attached directly to components and can be read with a hand scanner, for example, are another type of references.

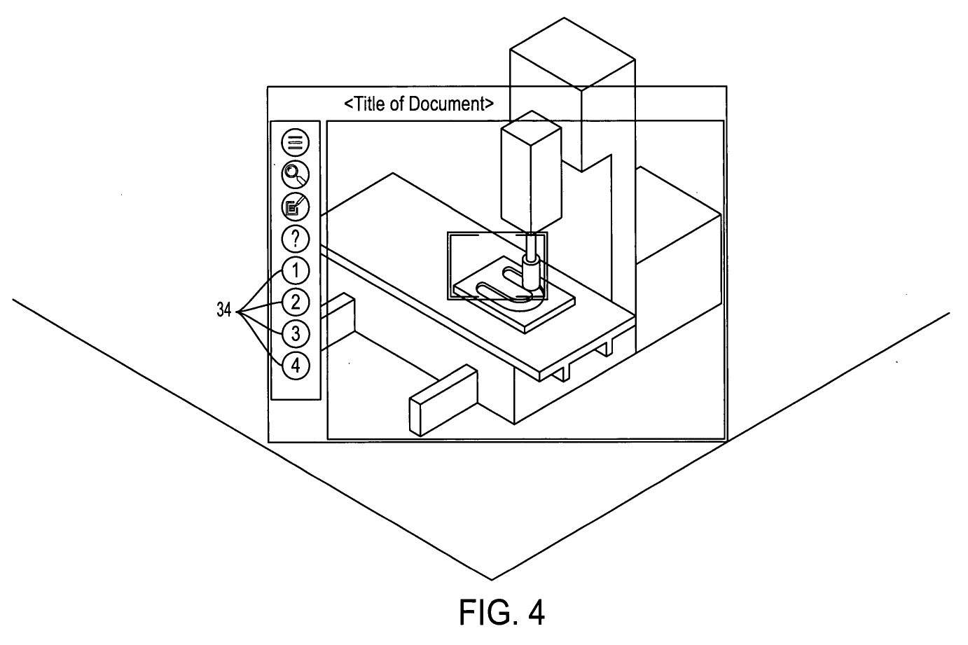

The variable (real) context acts like a dynamic filter which is applied to the database 7 of the total available information 8. The context manager 23 holds all the data that could be of interest to the respective user 3 at the given location and at the given point in time, while the context display 29 allows the user 3 access to the context objects 6 currently available. The context manager 23 manages the context objects 6 that are generated automatically or manually. Depending on the application case and/or configuration, the system notifies the user 3 that he can retrieve context-specific content (i.e., if he wants to “change the context”) or it automatically presents this content to him. In any case, certain context objects 6 are automatically accepted into the current context and thus into the context display 29 without confirmation by the user 3. In this way, the user 3 can directly retrieve the required information 8 (e.g., safety requirements for the room he has just entered). With other context objects 6, the user 3 is presented with a dialog in which he can decide whether he will accept the particular object into his context display 29. The granularity regulator 24 functions as an upstream filter here. Context objects 6 of a higher granularity than that selected are not presented to the user 3. New objects are presented to the user 3 when the actual spatial context changes due to movement or when the granularity changes. For the user 3, the current context objects 6 in the context display 29 are available at any time and can be selected directly. On a display device 1 which is designed as a hand-held display, for example, they appear as an object 28 in the bar at the lower edge of the display screen (see FIG. 3), or on a display device 1 in the form of a head-mounted display, they appear as a numbered object 34 in a vertical bar on the left edge of the display (see FIG. 4). Each of the context-specific menus 20 selectable via the objects 28, 34 contains three groups of entries: information 8, functions 9 and the removal 35 of the object from the current context. Although objects remain in the context display 29 until they are removed by the user 3, the context manager 23 always contains only currently “valid” context objects 6. For example, when an object is not displayed because of the granularity settings and it is no longer in the actual spatial context due to movement of the user 3, this context object 6 is deleted automatically.

Context is basically subdivided into three levels: level 1 is the coarsest subdivision and level 3 is the finest. Context can thus be determined and retrieved in different levels of granularity (fineness). In addition, there is a level 0 for characterizing objects which are displayed to the user in any case without demand. Table 1 shows which types of objects can be influenced by the granularity settings (i.e., are “granulable”). When moving inside a building, individual rooms (or subareas in large buildings) represent the context units at level 1. Level 2 pertains to major components, and level 3 pertains to smaller (sub-)components. The granularity is determined either automatically (e.g., according to workflow context) or manually.

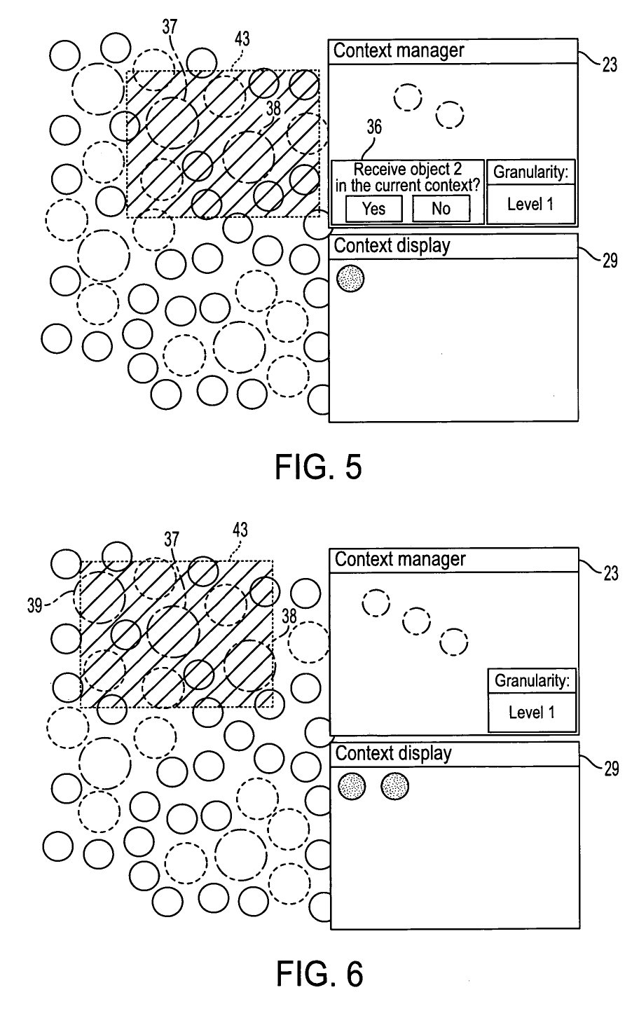

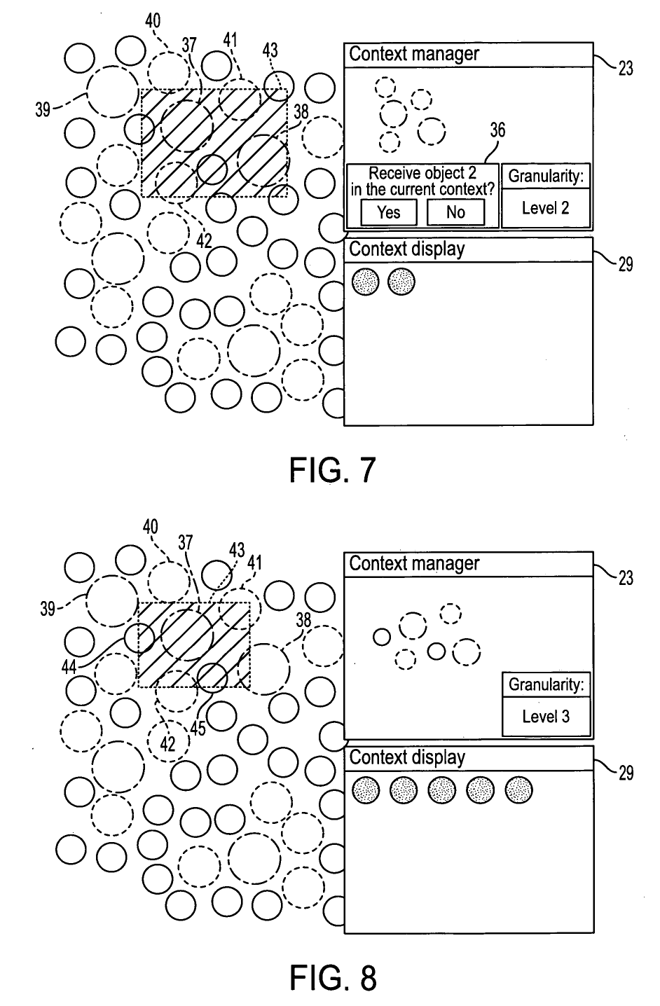

FIG. 5 through FIG. 8 illustrate the functioning of the context navigator 30. These do not represent visualizations of the actual user interface. They show the interaction of the context manager 23, granularity regulator 24 and user dialog 36 for receiving context objects 6 into the context display 29. Not shown are the actual context registering 21, 22 and the automatic display of level 0 objects. In FIG. 5, the granularity has been set at level 1, and thus the objects designated with reference notation 37 and 38 have been recognized. The left area in FIG. 5 through FIG. 8 illustrates the recognizable objects in the actual environment. The size and structuring characterize the assigned granularity. In the situation illustrated in FIG. 6, the user 3 has moved, so that now an additional level 1 object (reference number 39) has been detected by the automatic context registering 21 and has been generated as context object 6. The change in granularity to level 2 (FIG. 7) results in additional objects (reference numbers 40, 41 and 42) again being offered in the user dialog 36. It should be noted that with a higher granularity, the selection range 43 monitored by the context manager 23 is reduced to keep the quantity of objects recognized within a manageable range. In the example, this results in the object which is labeled with reference number 39 no longer being detected by the context manager. Finally, in the situation illustrated in FIG. 8, the granularity has been further refined. The objects labeled with reference numbers 44 and 45 in the context manager 23 appear as new objects, while the object labeled with reference number 40 is deleted. However, when objects in context manager 23 are no longer detected in context manager 23 (due to movement or due to a change in granularity with a subsequently restricted range of vision), they disappear only from the “offering” made by the context manager 23 to the user 3. All the objects in the context display 29 remain there until the user 3 removes them manually (regardless of the content currently in the context manager 23).

The notes function is not an actual component of context navigator 30, but it is included here because notes 46 involve content, where the context relevance plays a major role. The user 3 can make notes 46 on any objects at any point in time. Notes 46 already acquired are retrievable at any time, either as a “context-free” acquisition via a general search list or as a context-specific acquisition, directly via context-specific menus 20. Notes 46 are subdivided into three classes and can be characterized by the user 3 accordingly at the time of creation: private notes 46 can be retrieved only by the user 3 who created them. Public notes 46 are accessible for all users 3. Notes 46 relevant to data maintenance characterize instructions for required corrections to or changes in the database.

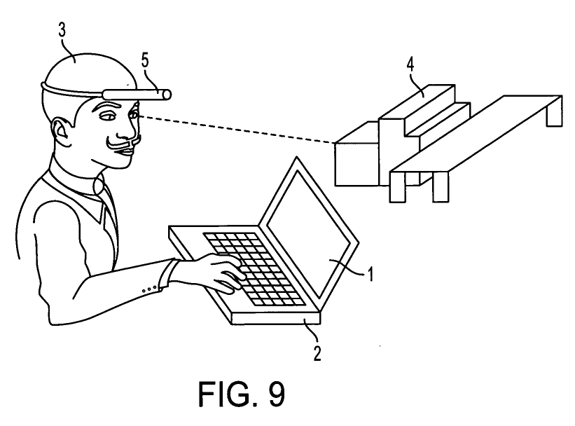

In another exemplary embodiment, FIG. 9 shows as user 3 of the context navigator 30 a service technician who is performing a vibration measurement on the spindle on machine XB420 (labeled with reference number 4). He is receiving information via a display device 1 (user interface) of his mobile computer system 2. He is using a tracking system 5.

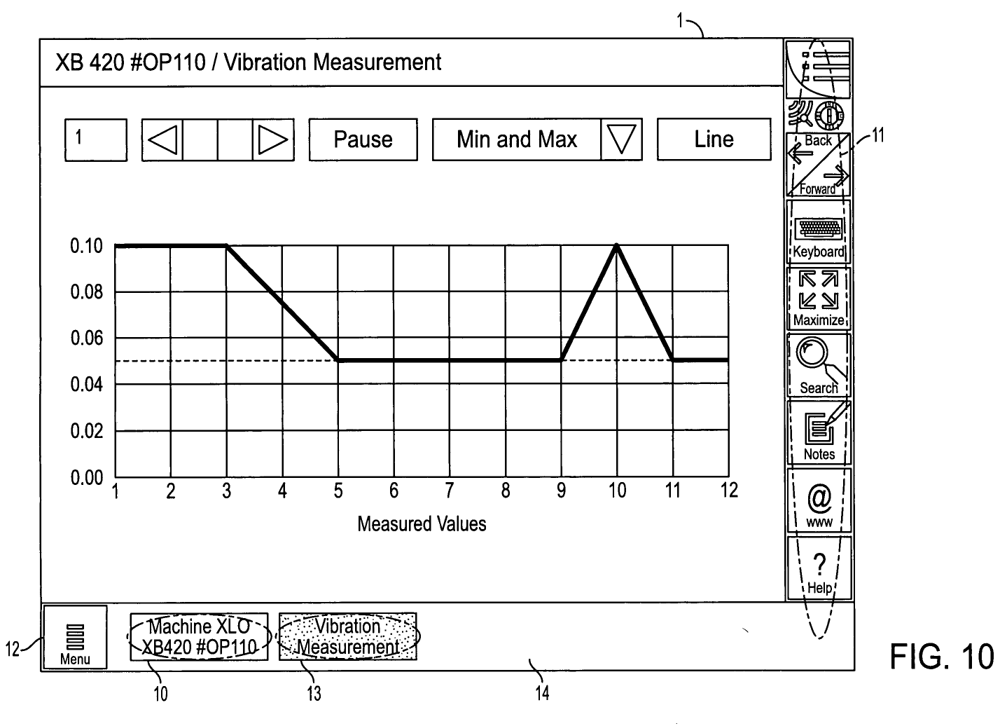

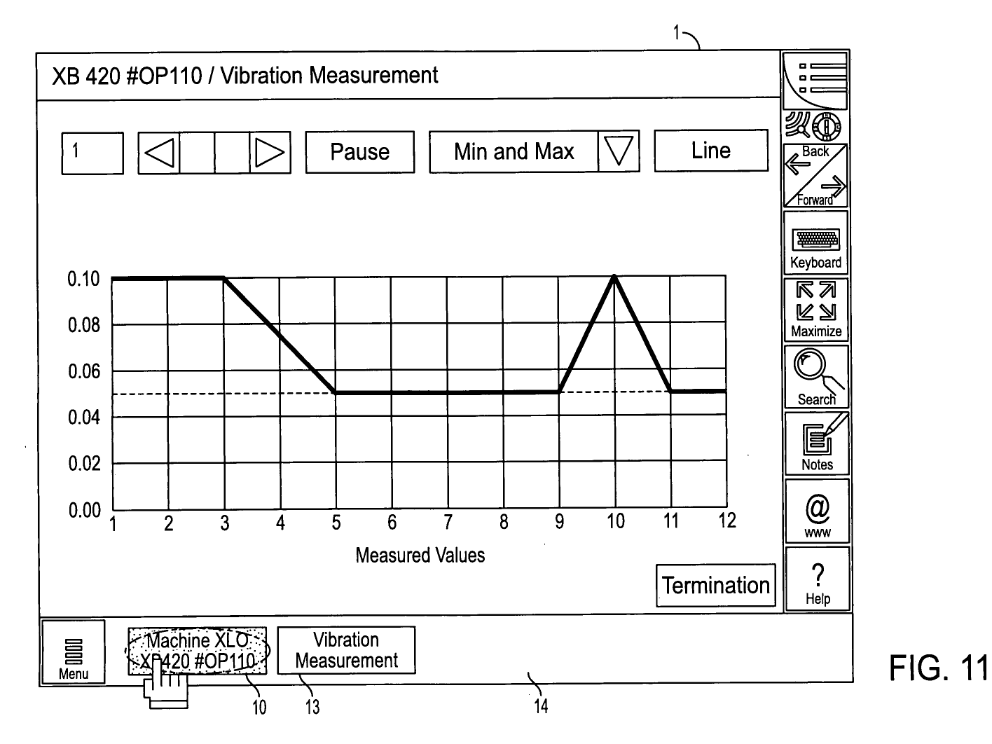

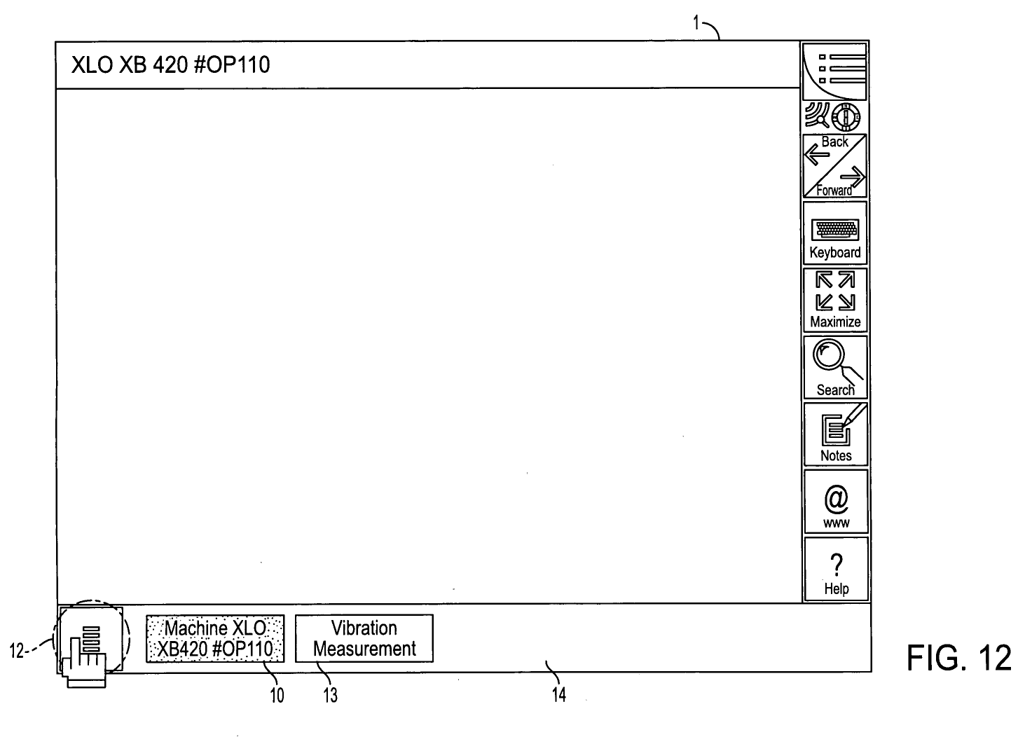

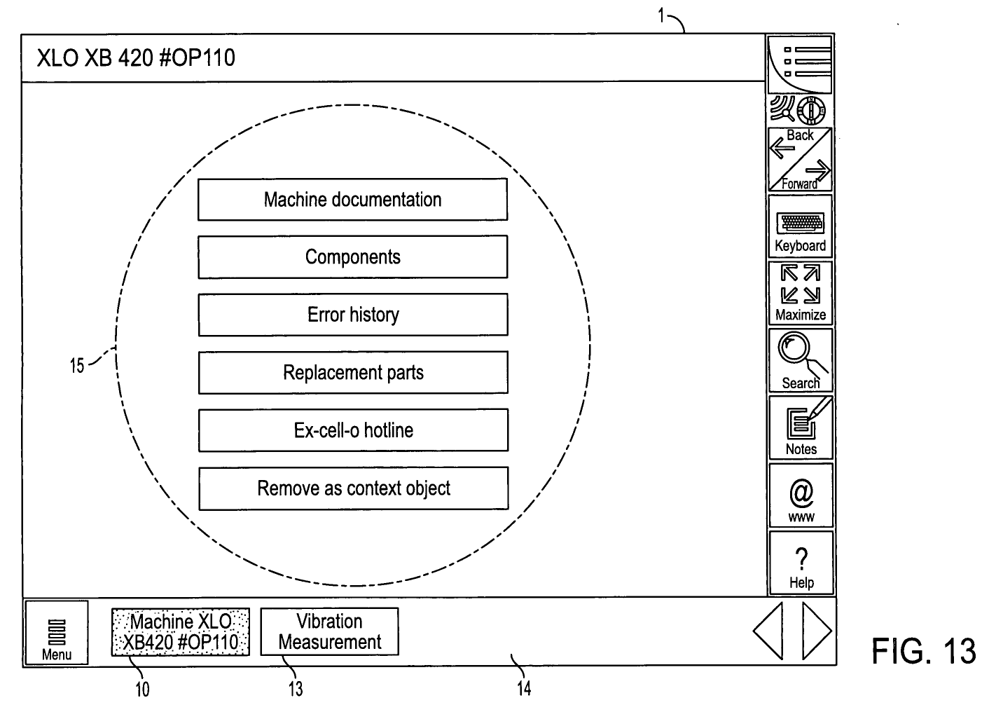

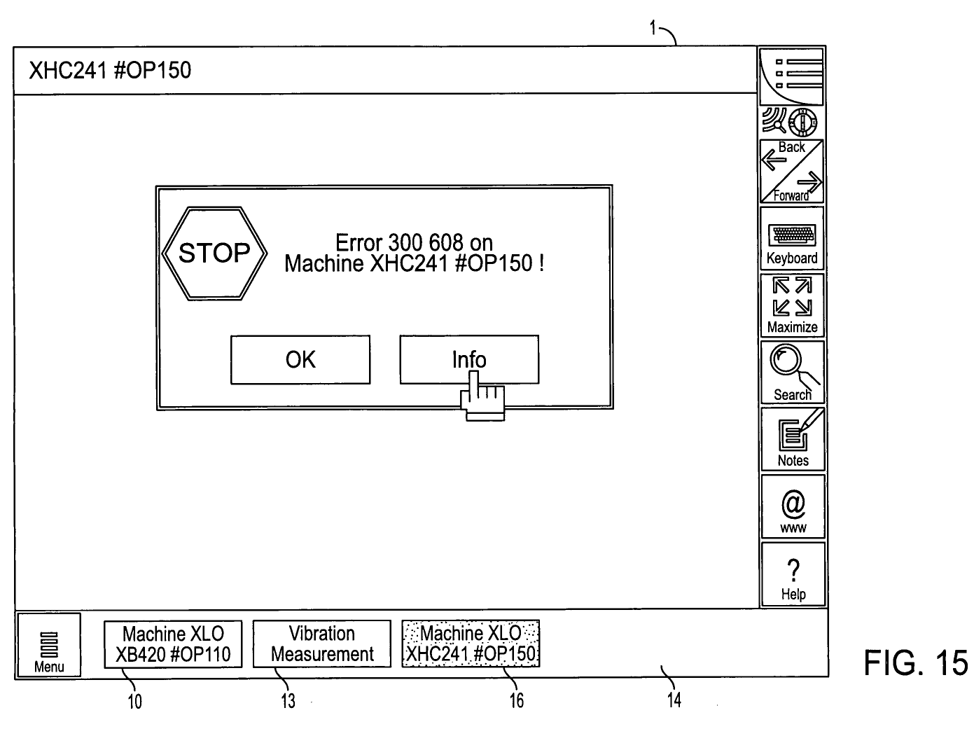

FIG. 10 shows a diagram of the display device 1 at this point in time. FIG. 11 through FIG. 20 show corresponding diagrams of the display device 1 in other steps. At the beginning, the user 3 is in the main context “machine XB 420” (shown by button 10 in taskbar 14), i.e., all the data (e.g., machine documentation, error history, etc.) that can be retrieved with button 12 in the main menu, for example, is based on this machine 4. The navigation options 11 which are also displayed remain the same over all contexts. The current job context of the user 3 is the vibration measurement at the moment (symbolized by the button labeled with reference number 13). The process of calling up the main menu is illustrated in FIG. 11 through FIG. 13. With the help of the corresponding button 10, the user 3 selects the main context (see FIG. 11). In the next step, he calls up the menu 15 for the main context with the button 12 provided for this (FIG. 12). This menu 15 is shown in FIG. 13. All the entries in this menu 15 are based on the current main context. Instead of the machine and the job context, a room or a certain component of a machine is also conceivable as a context that is potentially detectable by the tracking system 5.

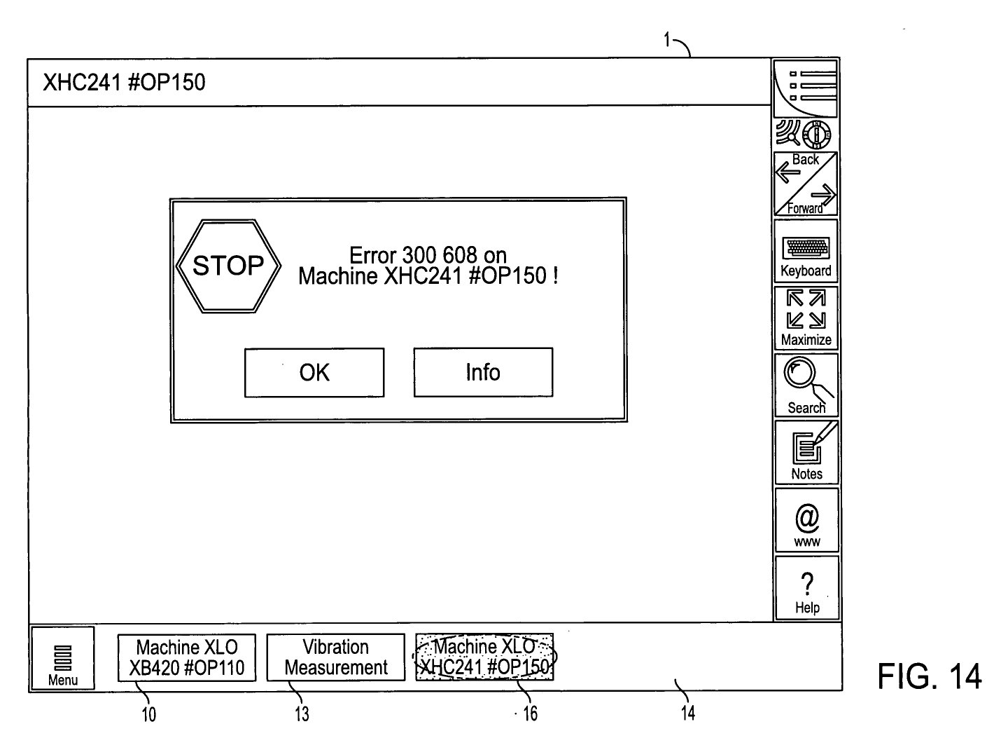

FIG. 14 through FIG. 20 show diagrams of the display device 1 for the case when a change in the context object 6 is induced by external information and/or an external event. An error occurs on another machine. The error is relayed to the mobile computer system 2 of the user 3, whereupon the current context object 16 changes, namely, to the faulty machine having the designation XHC 241 (see FIG. 14). All relevant retrievable information is now based on this machine, but the previous context objects selectable via buttons 10, 13 are still represented in taskbar 14 and can also be activated.

In the scenario just described, the context changes due to an event (the error). However, it is also conceivable for the user 3 to leave the first machine 4 and to approach another, for the tracking system 5 to detect this and for the new context object 16 to be registered in this way.

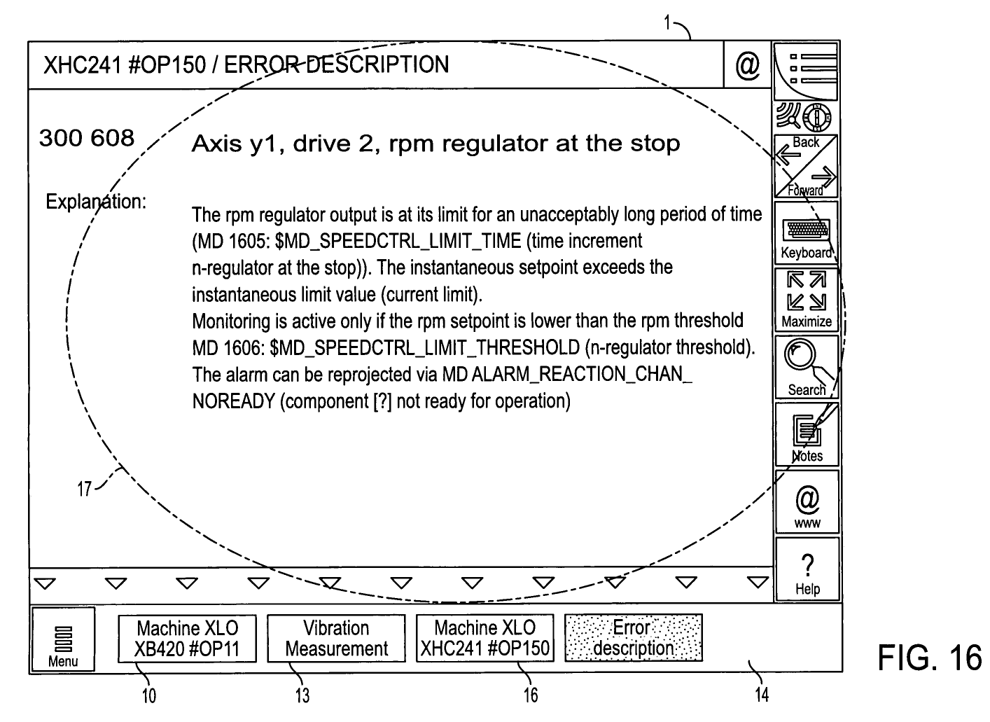

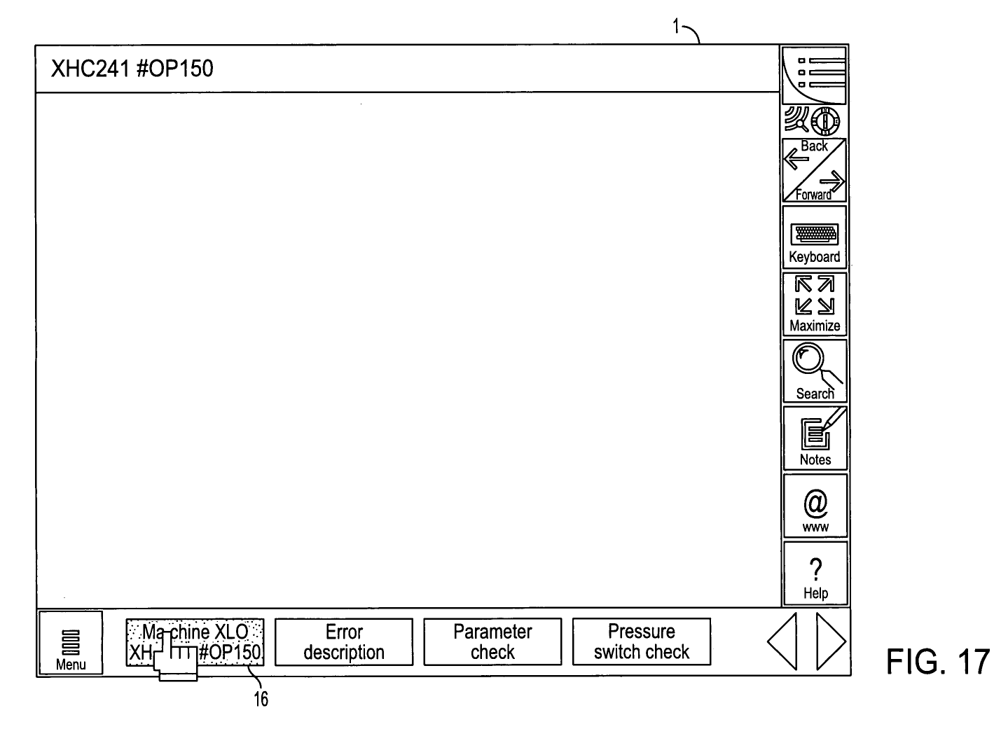

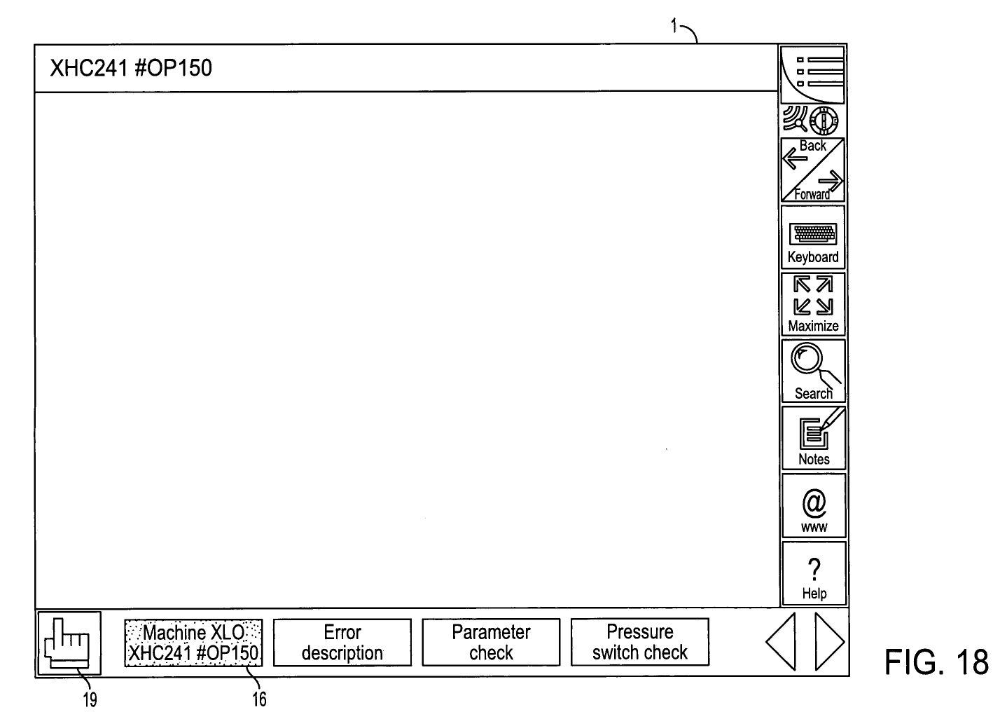

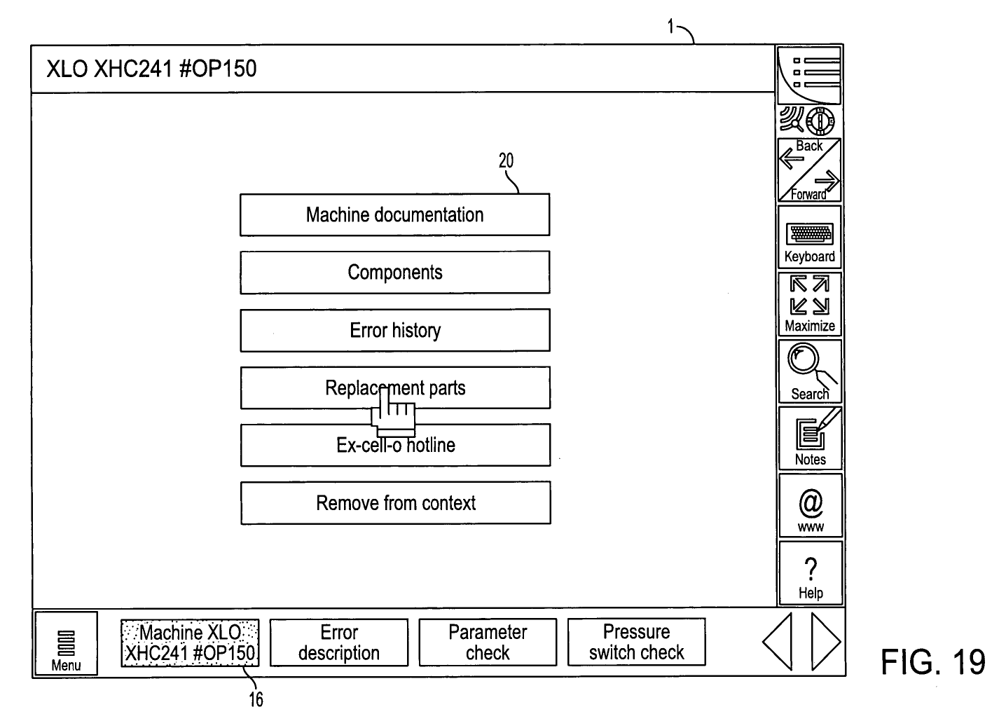

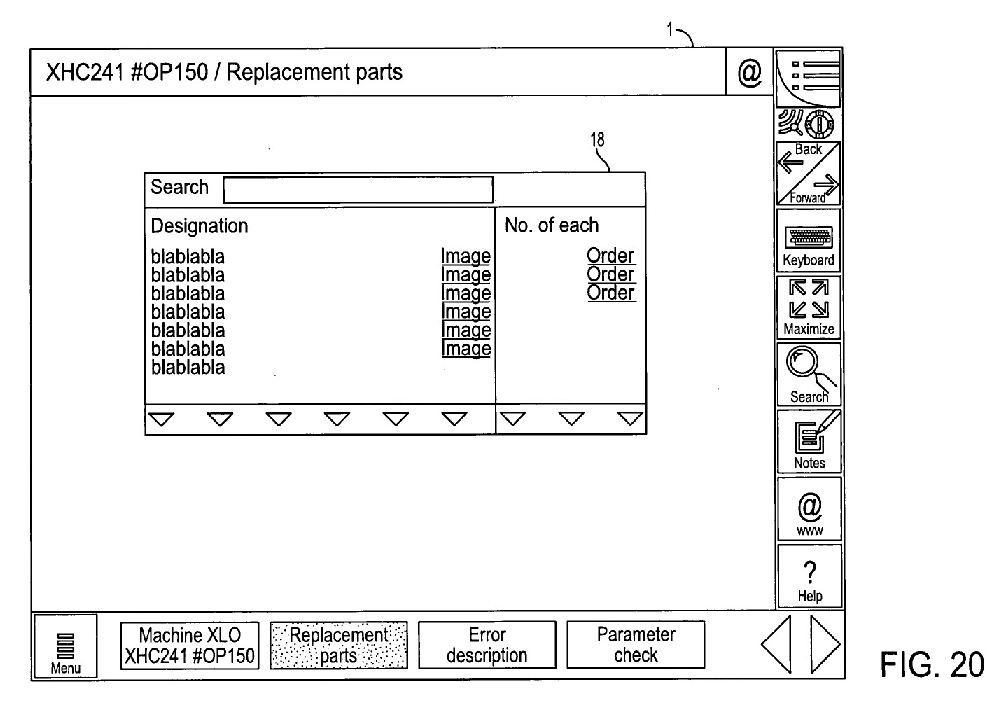

The user 3 wants to view information 17 about the error. Through context registering, the information system filters for him the information 17 relevant for the current context (see FIG. 16). This information is the result of a database query, filtered through a fitting context query for the main context object. In the next step, the user 3 wants to order replacement parts for the faulty machine. He activates the context object 16 “machine” (see FIG. 17) and calls up the main menu with the corresponding button 19 (see FIG. 18). The context-specific menu 20 (see FIG. 19) is now based on the context object 16 of the machine XHC 241 as the new main context. FIG. 20 shows the displayed list 18 of the replacement parts. The user 3 can thus manage a variety of information without having to conduct a lengthy search and/or having to overload his user interface. Therefore, he uses the dynamic and context-dependent display surface 1 described here and information systems for mobile computing, such as the context navigator 30.

A variety of technologies and information are available today to support the user 3 in tasks involved in service, maintenance and preduction. The decisive step represented by the context navigator 30 is based largely on the innovation of integrating the various available technologies and standardization of information access in a manner that actively supports the user 3. Technologies such as AR tracking and workflow management systems offer a great potential for user-friendly access to information 8 and functions 9 through context acquisition in a manner consistent with demand. The context navigator 30 ensures rapid, intuitive and user-friendly navigation and orientation in the information space and in actual space through the design and structuring of the user interface.

In summary, the present invention thus relates to a system and a method of representing information as well as a computer program product for implementing the method, which will improve the acquisition of information 8 and functions 9 from a database 7 from the standpoint of making it user friendly. This system for representing information contains a display device 1 for displaying information 8 and functions 9 that are retrieved as a function of a context of a user 3.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A system for acquiring information and functions from a database, comprising:
at least one context object containing a data record that has information and functions from the database and a context-specific menu that has a control component enabling access by a user to the context object,
a context manager managing the context objects and dynamically selecting the context objects as a function of a current context of the user, whereby the context manager offers the selected context objects to the user, and
a display device displaying a context display for visualizing the selected context objects,
wherein the context of the user is determined by at least one of a position in space, a work object and a work task of the user.

2. The system as recited in claim 1, wherein the context objects are assigned granularity levels, wherein the context manager comprises a granularity regulator selecting the context objects from a selection range as a function of a selected granularity level, and wherein the size of the selection range is dependent on the granularity level selected.

3. The system as recited in claim 2, wherein the assignment of the granularity levels of the context objects is at least one of an automatic assignment and a user-guided assignment of the granularity level.

4. The system as recited in claim 1, wherein the control component of the context-specific menu enables access by the user to the information and the functions and enables removal by the user of the selected context objects from the context display.

5. The system as recited in claim 1, further comprising at least one of an automatic context registration and a manual context registration providing, respectively, an automatic and a user-guided generation of the selected context objects from the context of the user.

6. The system as recited in claim 5, further comprising a tracking system detecting and recognizing real objects in a space, the tracking system comprising at least one image detection unit detecting the real objects and a computer unit processing information output by the image detection unit, wherein the processed information from the tracking system is provided to the automatic context registration for automatic generation of the context of the user.

7. The system as recited in claim 5, further comprising a workflow engine monitoring and controlling a work task of the user, wherein information supplied by the workflow engine is provided to the automatic context registration for automatic generation of the context of the user.

8. The system as recited in claim 1, wherein the context of the user is determined additionally as a function of communication partners of the user.

9. The system as recited in claim 5, further comprising references prompting the context manager to select the context objects from the context of the user by the manual context registration, wherein the references comprise at least one of entries in the context-specific menu or marks on real objects in a space.

10. The system as recited in claim 1, wherein the display device is a mobile display.

11. The system as recited in one of the preceding claims, wherein the control component selects the context objects to be visualized on the display device by the user.

12. The system as recited in claim 1, further comprising a further control component generating messages regarding external information, wherein the context of the user is determined additionally as a function of the messages.

13. The system as recited in claim 1, wherein the database is configured for receiving notes of the user that are linked to the context of the user, the notes being classified as one of private, public, and relevant to data maintenance.

14. A method of acquiring information and functions from a database, wherein at least one context object contains a data record comprising information and functions from the database and a context-specific menu has a control component enabling a user to access the context object, comprising:
managing the context objects and dynamically selecting the context objects as a function of a current context of the user;
determining the current context of the user by at least one of a spatial position, a work object and a work task of the user;
offering the selected context objects to the user; and
displaying a context display of ones of the selected context objects.

15. The method as recited in claim 14, further comprising:
assigning the context objects granularity levels;
selecting a granularity level; and
selecting the context objects from a selection range as a function of the selected granularity level;
wherein the size of the selection range is dependent on the selected granularity level.

16. The method as recited in claim 15, wherein the assigning of the granularity levels of the context objects is at least one of an automatic assignment and a user-guided assignment of the granularity level.

17. The method as recited in claim 14, wherein the control component of the context-specific menu enables access by the user to the information and the functions and enables removal by the user of the selected context objects from the context display.

18. The method as recited in claim 14, further comprising at least one of:
automatic context registration, whereby the selected context objects are automatically generated from the context of the user; and
a manual context registration, whereby the selected context objects are generated manually in a user-guided operation.

19. The method as recited in claim 18, further comprising:
detecting and recognizing real objects in a space, comprising detecting the real objects and processing information therefrom; and
providing the processed information to the automatic context registration.

20. The method as recited in claim 18, further comprising:
monitoring and controlling a work task of the user; and
providing information generated by the monitoring and the controlling to the automatic context registration.

21. The method as recited in claim 14, wherein the current context of the user is determined additionally as a function of communication partners of the user.

22. The method as recited in claim 18, further comprising:
utilizing references to prompt selection of the context objects from the current context of the user by the manual context registration, wherein the references comprise at least one of entries in the context-specific menu or marks on real objects in a space.

23. The method as recited in claim 14, wherein the context display is displayed on a mobile display.

24. The method as recited in claim 14, wherein the user selects the context objects to be displayed in the context display via the control component.

25. The method as recited in claim 14, further comprising:
generating messages regarding external information, wherein the context of the user is determined additionally as a function of the messages.

26. The method as recited in claim 14, wherein the database is configured for receiving notes from the user that are linked to the context of the user, the notes being classified as one of private, public, and relevant to data maintenance.

27. A computer program product comprising instructions readable by a computing device for performing a method of acquiring information and functions from a database, wherein a plurality of context objects contain respective data records comprising information and functions from the database, comprising:
managing the context objects and dynamically selecting the context objects as a function of a current context of the user;
determining the current context of the user by at least one of a spatial position, a work object and a work task of the user;
offering the selected context objects to the user; and
displaying a context display of ones of the selected context objects as the acquired information and functions.
